(19) United States
(12) Patent Application Publication
(10) Pub. No.: US 2019/0186355 A1
(43) Pub. Date: Jun. 20, 2019

(54) THERMAL BARRIERS FOR ENGINES AND METHODS OF MAKING THE SAME

(71) Applicant: CORNING INCORPORATED, CORNING, NY (US)

(72) Inventors: Dana Craig Bookbinder, Corning, NY (US); Roy Joseph Bourcier, Corning, NY (US); Wlliam Edward Lock, Horseheads, NY (US); Richard Curwood Peterson, Elmira Heights, NY (US); Irene Marjorie Slater, Lindley, NY (US); Pushkar Tandon, Painted Post, NY (US)

(21) Appl. No.: 16/327,950

(22) PCT Filed: Aug. 25, 2017
(86) PCT No.: PCT/US2017/048577

§ 371 Date: Feb. 25, 2019

Related U.S. Application Data
(60) Provisional application No. 62/379,429, filed on Aug. 25, 2016.

(51) Int. Cl. F02B 77/02; F02B 77/11; F01N 13/14; F02B 23/08; F02F 3/14; F02F 3/24; F02F 1/00

(52) U.S. Cl. CPC F02B 77/02; F02B 77/11; F01N 13/14; F02F 1/004; F02F 3/14; F02F 3/24; F02B 23/08

(57) ABSTRACT

A thermal barrier for component surfaces of an engine. The thermal barrier includes a plurality of modules, each module includes a shield. An edge of at least one shield in the array is spaced apart from an edge of an adjacent shield in the array.

This application claims the benefit of priority under 35 U.S.C. § 119 of U.S. Provisional Application Ser. No. 62/379,429 filed on Aug. 25, 2016, the content of which is relied upon and incorporated herein by reference in its entirety.

### BACKGROUND

### Field

The present disclosure relates generally to thermal barriers for component surfaces in an engine.

### TECHNICAL BACKGROUND

The efficiency of combustion engines may be improved by retaining heat from ignited fuel in the combustion chamber. This can be accomplished by minimizing heat loss to the surrounding engine. One solution has been to insulate parts of the combustion chamber. A problem with insulating the combustion chamber from the surrounding engine may be creating a reliable bond between the thermal barrier and combustion chamber component surfaces.

Accordingly, a need exists for improved thermal barriers within combustion engines.

### SUMMARY

According to an embodiment of the present disclosure, a thermal barrier is disclosed. In embodiments, the thermal barrier comprises an array of module each comprising a metallic shield. In embodiments, an edge of at least one shield in the module array overlaps the first or second edge of an adjacent shield in the module array.

According to an embodiment of the present disclosure, a thermal barrier is disclosed. In embodiments, the thermal barrier comprises an array of module each comprising a metallic shield. In embodiments, each shield in the module array comprises a body with a mounting portion and an overlapping portion. In embodiments, the overlapping portion of at least one shield in the module array overlaps at least a segment of the mounting portion of at least one adjacent shield in the module array.

According to an embodiment of the present disclosure, a method of making a thermal barrier is disclosed. In embodiments, making the thermal barrier comprises joining a portion of each shield in the module array directly or indirectly with at least one of the surfaces within an internal combustion engine.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings.

FIG. 1 is a cross-sectional view of a combustion chamber in an engine during an intake stroke according to an exemplary embodiment.

FIG. 2 is a cross-sectional view of the combustion chamber in the engine of FIG. 1 during an exhaust stroke according to an exemplary embodiment.

FIG. 3 is a plot of change in brake thermal efficiency (%) of an internal combustion engine at cruise operating conditions vs. piston thermal conductivity at 400° C. (W/m·° C.).

FIG. 4 is a perspective view of a thermal barrier on a surface within a combustion chamber of an engine according to exemplary embodiments.

FIG. 5 is another perspective view of the thermal barrier in FIG. 4 on a surface within a combustion chamber of an engine according to exemplary embodiments.

FIG. 6 is a cross-sectional view of the thermal barrier in FIG. 4 on a surface within a combustion chamber of an engine according to exemplary embodiments.

FIG. 7 is a perspective view of a thermal barrier on a surface within a combustion chamber of an engine according to exemplary embodiments.

FIG. 8 is a perspective view of a thermal barrier on a surface within a combustion chamber of an engine according to exemplary embodiments.

FIG. 9 is another perspective view of the thermal barrier in FIG. 8 on a surface within a combustion chamber of an engine according to exemplary embodiments.

FIG. 10 is a perspective view of a thermal barrier on a surface within a combustion chamber of an engine according to exemplary embodiments.

FIG. 11 is another perspective view of the thermal barrier in FIG. 10 on a surface within a combustion chamber of an engine according to exemplary embodiments.

FIG. 12 is a perspective view of a thermal barrier on a surface within a combustion chamber of an engine according to exemplary embodiments.

FIG. 13 is an overhead view of the thermal barrier in FIG. 12 on a surface within a combustion chamber of an engine according to exemplary embodiments.

FIG. 14 is a cross-sectional view of the thermal barrier in FIG. 12 on a surface within a combustion chamber of an engine according to exemplary embodiments.

FIG. 15 is another cross-sectional view of the thermal barrier in FIG. 12 on a surface within a combustion chamber of an engine according to exemplary embodiments.

FIG. 16 is an additional cross-sectional view of the thermal barrier in FIG. 12 on a surface within a combustion chamber of an engine according to exemplary embodiments.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

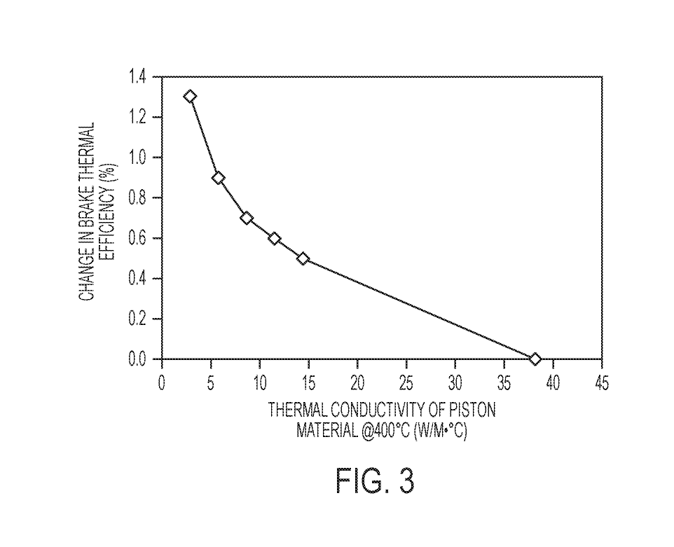

Engine fuel efficiency is affected by the thermal conductivity of the materials used to make the various components of an engine. This is particularly true for components within the combustion chamber of an engine (e.g., wall of the combustion chamber, pistons, valves, exhaust ports, manifolds, etc.). The higher the thermal conductivity of materials used in the combustion chamber, the more combustion energy lost to heat energy. By lowering the thermal conductivity of materials directly exposed to the combustion reaction, more energy of combustion is available for performing work and powering the engine (i.e., to drive the piston). That is, heat of combustion that is not lost to heat energy can be used to drive a turbocharger in the exhaust manifold and/or more effectively light off the catalytic converter during a cold-start of the engine. In addition, lowering the thermal conductivity of materials directly exposed to the combustion reaction may reduce the heat load on the engine's cooling system and thereby potentially improve aerodynamics of the vehicle with less air being diverted from outside the vehicle for the cooling system. Accordingly, the overall efficiency of the vehicle and engine (including fuel efficiency) may be improved with thermally resistant materials. FIG. 3 provides a plot of change in brake thermal efficiency (%) of an internal combustion engine at cruise operating conditions vs. the piston material's thermal conductivity at 400° C. (W/m·° C.). FIG. 3 illustrates the effect of piston material thermal conductivity on brake thermal efficiency of an engine at cruise operating conditions. The trend of FIG. 3 evidences that the increase in efficiency of an engine at cruise conditions may improve exponentially or in a non-linear fashion by reducing the thermal conductivity of materials (for the appropriate temperature range) used within the combustion chamber.

Conventional methods for lowering the thermal conductivity of materials within the combustion chamber have included the use of thermal barriers. Conventional thermal barriers for combustion chambers of internal combustion engines may have one or more of several problems. One major shortcoming for conventional thermal barriers may be that the thermal barrier spalls or separates from the surface within the combustion chamber when exposed to the violent combustion kinetics, high pressures (e.g., 10 bars-500 bars), and high gas temperatures (e.g., 1000° C.-3000° C.) therein. Spalling of thermal barriers including brittle ceramic materials into the combustion chamber can cause damage (e.g., gouge, plug, etc.) to other engine components and the catalytic convertor. Another shortcoming of conventional thermal barriers may be insufficient thermal resistivity properties or a different coefficient of thermal expansion (CTE) than the combustion chamber surface which may lead to separation at high temperatures. Yet another shortcoming may be non-uniform thicknesses of conventional thermal barriers on engine component surfaces. Another short coming of conventional thermal barriers may be the development of mechanical strain within surfaces of the thermal barrier exposed to temperature cycling within a combustion chamber during engine operation. In conventional thermal barriers, thermal strain is sometimes managed by using low CTE coatings or compositional gradients through the coating thickness. These measures, however, constrain the materials available for use as a thermal barrier. Yet another shortcoming of conventional thermal barriers is their failure to utilize convective cooling mechanisms within the combustion chamber.

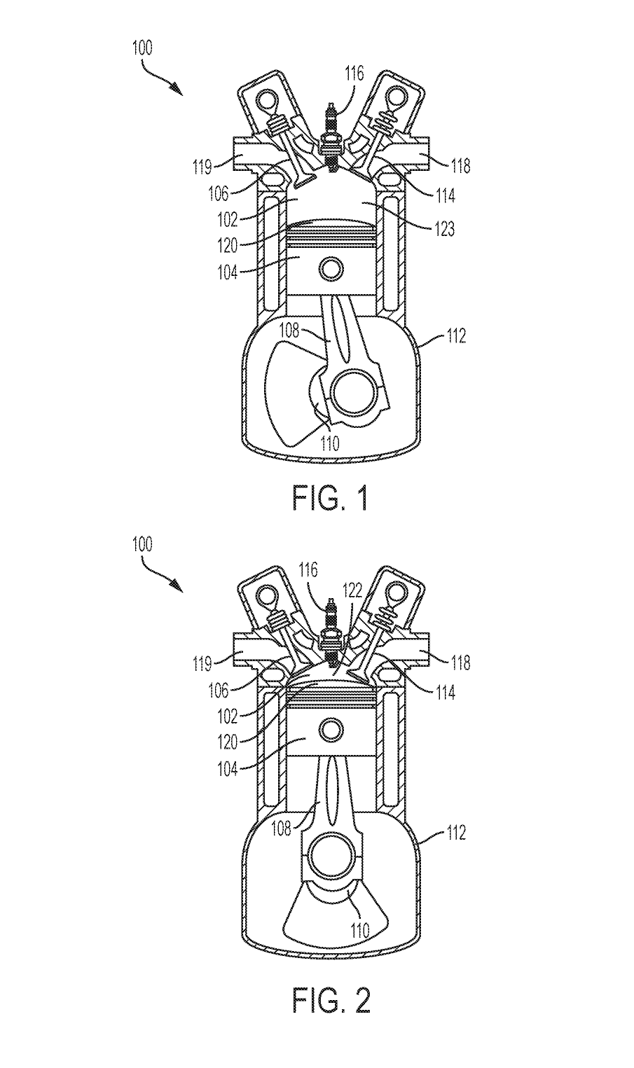

The present application is directed to a thermal barrier 200 on any metallic surface within an internal combustion engine 100. FIG. 1 provides a cross-sectional view of example engine 100 during an intake stroke. FIG. 2 provides another cross-sectional view of example engine 100 with piston 104 in a full-exhaust stroke position. Engine 100 of the present disclosure may be gasoline, diesel, natural gas, propane, or any other liquid or gas hydrocarbon powered internal combustion engine including any number (e.g., 1, 2, 3, 4, 5, 6, . . . , 12, . . . ) of combustion chambers. Engine 100 includes a number of components including a combustion chamber 102 with a piston 104 therein. Piston 104 is connected to a crankshaft 110 by a connecting rod 108 within a crankcase 112 of engine 100. Piston 104 includes a top surface 120 adjacent combustion chamber 102. Piston top surface may be flat, bowled, domed, or any combination thereof. Piston 104 may be made from carbon steel, aluminum, or other metals typically used in automotive applications. An intake valve 106, an intake duct 119, an exhaust valve 114, an exhaust duct 118, and a spark/glow plug 116 are also adjacent combustion chamber 102. Of course other components and configurations of engine 100 are possible and are in accordance with the present disclosure.

In FIG. 2, intake valve 106 is closed and exhaust valve 114 is open (when piston 104 is at a full-exhaust stroke position) connecting exhaust duct 118 with combustion chamber 102 and thereby forming a chamber exhaust volume 122. Chamber exhaust volume 122 is defined by wall surfaces and end surfaces of combustion chamber 102, a surface of intake valve 106, a surface of exhaust valve 114, top surface 120 of piston 104, and walls of exhaust duct 118 (which may include a turbocharger). In another embodiment, intake valve 106 and exhaust valve 114 are closed (when piston 104 is at a full-compression stroke position) thereby forming a chamber compression volume 121 (not shown). Chamber compression volume 121 is defined by walls and top surfaces of combustion chamber 102, a surface of intake valve 106, a surface of exhaust valve 114, and top surface 120 of piston 104. In yet another embodiment, intake valve 106 is open and exhaust valve 114 is closed (when piston 104 is at a full-intake stroke position) connecting intake duct 119 with combustion chamber 102 and thereby forming a chamber intake volume 123. Chamber intake volume 123 is defined by wall surfaces and end surfaces of combustion chamber 102, a surface of intake valve 106, a surface of exhaust valve 114, top surface 120 of piston 104, and walls of intake duct 119.

Thermal barrier 200 of the present disclosure may benefit from the non-steady state operation of combustion engines. Specifically, thermal barrier 200 may protect a surface 101 in the combustion chamber during ignition and combustion of the reactants, which will cause thermal barrier 200 to heat up significantly. That is, thermal barrier 200 may also act as a “shield” or a “finned heat sink” to reduce thermal radiation to the piston surface from each combustion event. Following each combustion event in the chamber, during the remaining interval of the crank cycle, thermal barrier 200 may be convectively cooled by outgoing combustion products and incoming combustion reactants such that heat absorbed by thermal barrier 200 during combustion does not radiate to the piston surface. That is, heat of combustion captured by thermal barrier 200 may be convectively transferred or released to combustion products exiting the chamber and combustion reactants entering the chamber so that a majority of the heat of combustion does not reach the combustion chamber surfaces. Thus, thermal barrier 200 acts as a “finned heat sink” or a “heat shield” for surface 101.

Thermal barrier 200 of the present disclosure may be on any metallic surface within engine 100. In an exemplary embodiment, thermal barrier 200 is on a metallic surface 101 within combustion chamber 102. Metallic surface 101 may be surfaces defining compression exhaust volume 121, surfaces defining chamber exhaust volume 122, or surfaces defining chamber intake volume 123. In one embodiment, surface 101 may not be wall surfaces of combustion chamber 102 contacted by piston 104. That is, thermal barrier 200 may be excluded from surfaces in chamber 102 subjected to mechanical friction from piston 104 or areas along the crevice quench that may wear or separate thermal barrier 200 from that surface. In another exemplary embodiment, metallic surface 101 is piston top surface 120, wall surfaces and end surfaces of combustion chamber 102, a surface of intake valve 106, a surface of exhaust valve 114, walls of exhaust duct 118, or walls of intake duct 119.

Thermal barrier 200 of the present disclosure includes an array of modules 201. The array of modules 201 (also called “module array” herein) may include any number of modules 201 greater than 1 module. In embodiments, each module 201 in the array includes a fin or shield 206. The overall length and width of thermal barrier 200 including the array of modules 201 can have any suitable lateral dimensions (e.g., from about 0.1 mm to about 100 cm), including substantially equal dimensions. In embodiments, thermal barrier 200 includes lateral dimensions substantially equivalent to the applicable surface 101 within combustion chamber 102. In embodiments, thermal barrier 200 conforms substantially to the 2-dimensional and/or 3-dimensional contours of metallic surface 101. That is, the shape of thermal barrier 200 may conform to the rounded or non-uniform shapes of surface 101 to which it is connected, including a curved piston top surface 120. In embodiments, thermal barrier 200 may be discontinuous on surface 101 and localized to “hot spots” within the combustion chamber.

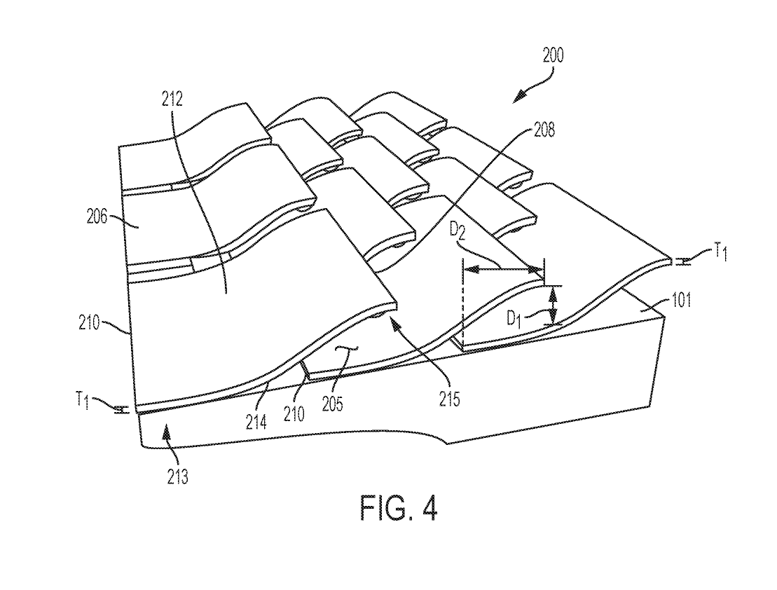

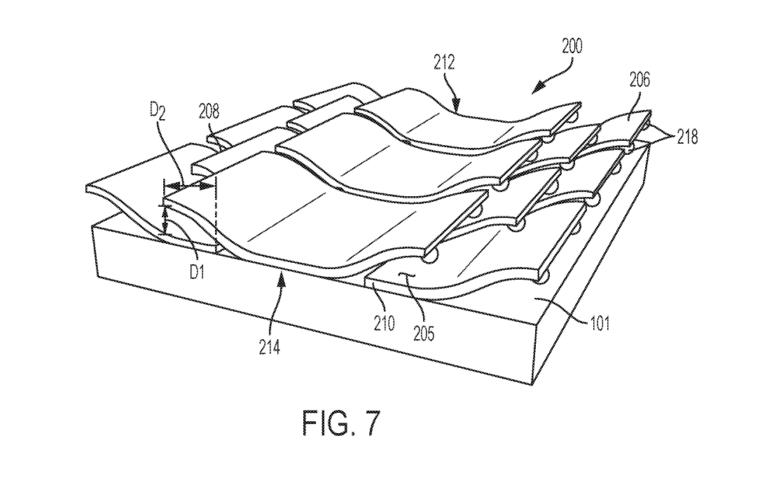

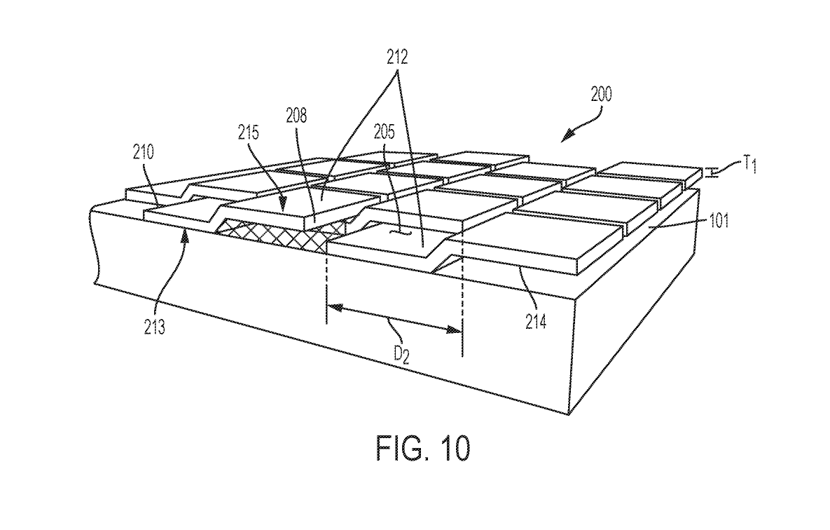

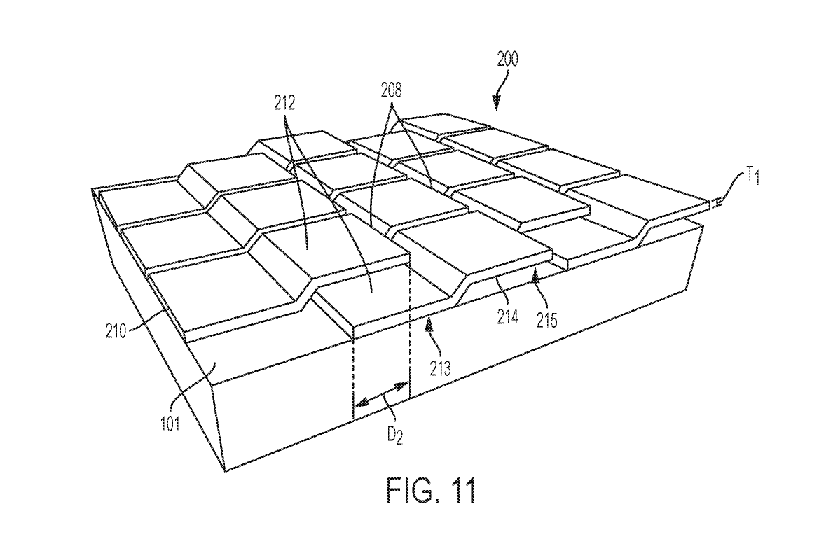

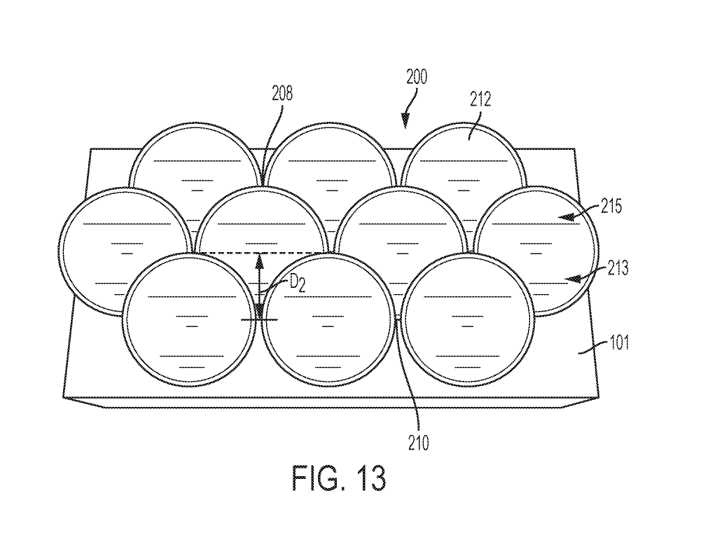

FIGS. 4-14 provide embodiments of thermal barrier 200 on surface 101. Thermal barrier 200 includes an array of modules each including a metallic shield 206 or fin. Each shield 206 in the module array includes a body with a first edge 208 opposite a second edge 210. Each shield 206 in the module array also includes an upper portion 212 opposite a lower portion 214. In embodiments, at least a segment of lower portion 214 of each shield 206 in the module array joins directly or indirectly with surface 101. In embodiments, the segment of lower portion 214 of each shield 206 joining directly or indirectly with surface 101 is contiguous second edge 210 of each shield 206 (as shown in FIG. 4).

In embodiments, at least a segment of lower portion 214 is spaced apart from upper portion 212 of an adjacent shield 206 in the module array by a first distance D1. In embodiments, first edge 208 of at least one shield 206 in the module array is spaced apart from upper portion 212 of an adjacent shield in the module array by a distance D1. In embodiments, first edge 208 (contiguous lower portion 214) of at least one shield 206 in the module array is spaced apart by distance D1 from upper portion 212 of an adjacent shield in the module array. Distance D1 may be substantially orthogonal to surface 101. In embodiments, at least a segment of lower portion 214 of each shield 206 is substantially parallel to surface 101. Shield 206 and surface 101 may be joined by metallic bonding, metal-to-metal bonding, or direct mechanical attachment. The connection between shield 206 and surface 101 is configured to resist the combustion temperatures and pressures within combustion chamber 102 during operation of engine 100. For example, shield 206 may resist spalling from surface 101 for ≥100,000 miles inside operating engine 100. Shield 206 may be applied to surface 101 via 3-D printing, metallic plating, welding (arc, laser, plasma, or friction), brazing, plasma spraying, mechanical fastening, or other conventional methods of creating metallic bonding or metal-to-metal bonds.

As shown in FIGS. 4-7, first edge 208 of at least one shield 206 in the module array overlaps an edge 208, 210 of an adjacent shield 206 in the module array by a second distance D2. That is, the first edge 208 of at least one shield 206 in the module array overlaps with first edge 208 or second edge 210 of at least one adjacent shield 206 in the module array by second distance D2. In embodiments, shield edges that overlap may be in contact or spaced apart. In embodiments, one shield edge that overlaps another shield edge may be further described as above, overhanging, or on top of the other shield edge. In embodiments, first edge 208 of at least 30% of shields 206 in the module array overlap the first or second edge 208, 210 of at least one adjacent shield 206 in the module array by distance D2. In embodiments, first edge 208 of all shields 206 in the module array overlap the first or second edge 208, 210 of an adjacent shield 206 in the module array by distance D2. In embodiments, distance D2 is measured substantially parallel to surface 101. Distance D2 may be measured at room temperature (e.g., 25° C.). In embodiments, distance D2 may be measured during operation of engine 100 when thermal expansion of adjacent shields 206 forms overlap distance D2. That is, edges of adjacent shields 206 in the module array may not overlap at room temperature and may have to be measured at elevated temperatures (e.g., during operation of the engine) when the shields 206 are in a state of thermal expansion.

In additional embodiments, each shield 206 in the module array includes a body with a mounting portion 213 and an overlapping portion 215. Mounting portion 213 connects directly or indirectly to overlapping portion 215 in an individual shield 206. In embodiments, mounting portion 213 of each shield 206 in the module array joins directly or indirectly with surface 101. In embodiments, overlapping portion 215 of at least one shield 206 in the module array is spaced apart by distance D1 from mounting portion 213 of an adjacent shield 206 in the module array. In embodiments, distance D1 is measured substantially orthogonal to surface 101. Distance D1 may be measured at room temperature (e.g., 25° C.) or during operation of engine 100. In further embodiments, overlapping portion 215 of at least one shield 206 in the module array overlaps at least a fraction of mounting portion 213 of at least one adjacent shield 206 in the module array. In embodiments, the fraction of mounting portion 213 overlapped by overlapping portion 215 of at least one shield 206 in the module array may be in contact or spaced apart with overlapping portion 215. In embodiments, overlapping portion 215 may be further described as above, overhanging, or on top of a fraction of mounting portion 213. Overlapping portion 215 of at least one shield 206 in the module array overlaps an edge 208, 210 of at least one adjacent shield 206 in the module array by distance D2. In embodiments, overlapping portion 215 of at least 30% of shields 206 in the module array overlap mounting portion 213 of at least one adjacent shield 206 in the module array by distance D2. In embodiments, overlapping portion 215 of all shields 206 in the module array overlap mounting portion 213 of an adjacent shield 206 in the module array by distance D2.

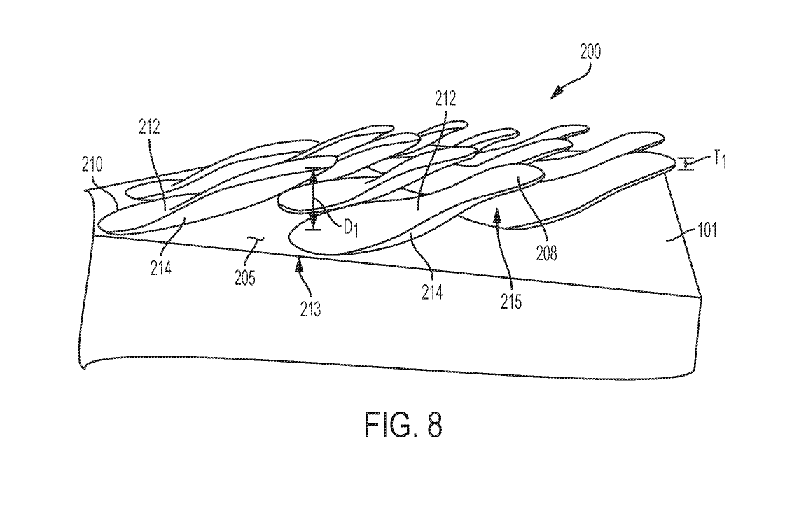

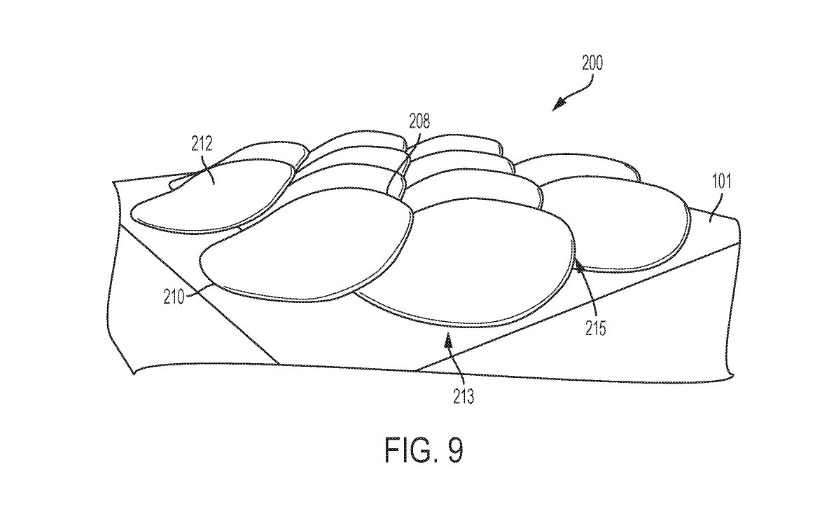

The body of each shield 206 in the module array may be rectangular (as shown in FIGS. 4-7 & 10-11), square, hexagonal, triangular, heptagonal, circular (as shown in FIGS. 8-9 & 12-16), annular, and combinations thereof. The body of each shield 206 may also be in the shape of a fin. Of course other shapes and polygons are in accordance with the present disclosure. In embodiments, thickness T1 of each shield 206 is defined between upper portion 212 and lower portion 214. In embodiments, shield 206 is substantially solid between upper portion 212 and lower portion 214. Thickness T1 of shield 206 may be from about 0.001 mm to about 5 mm, or from about 0.1 mm to about 2 mm, or even from about 0.1 mm to about 1 mm. In addition to thickness T1, each shield 206 also includes a length and a width. In embodiments, thickness T1 is substantially uniform across the length and the width of shield 206. In embodiments, the body of each shield 206 in the module array includes a substantially uniform (e.g., +/−1 mm) thickness T1 between upper portion 212 and lower portion 214. As shown in FIG. 4, thickness T1 of shield 206 may be measured from the top of surface 101 joined to lower portion 214 of shield 206. Upper portion 212 of each shield 206 may be configured for direct exposure to the combustion reaction (and associated temperatures and pressures) in combustion chamber 102. In embodiments, upper portion 212 of each shield 206 may have a variation tolerance along its surface in compliance with tolerances required for combustion chamber 102 in engine 100, such as ≤1 mm, or ≤0.01 mm.

In embodiments, a single or plurality of modules in thermal barrier 200 includes a support 202. In embodiments of thermal barrier 200, shield 206 of at least one module joins indirectly to surface 101 by a support 202. Each support 202 includes a body with a first end opposite a second end, thereby defining a thickness T2. Each support 202 has a height or thickness T2 between its opposite ends, as well as a width (or diameter). In embodiments, the first end or second end of support 202 joins directly or indirectly with surface 101. In embodiments, the first or second end of support 202 (opposite the end joining surface 101) joins directly or indirectly with shield 206 in each module. Support 202 may be joined to surface 101 and shield 206 by metallic bonding, metal-to-metal bonding, or direct mechanical attachment. In other embodiments, shield 206 and support 202 may be integrally formed together such that bonding of individual pieces is not necessary. In embodiments where a module includes a support 202, lower portion 214 or mounting portion 213 is spaced apart from surface 101 by a third distance D3. Distance D3 may be substantially equivalent to the height of its support 202. Distance D3 may be from about 0.001 microns to about 10 mm, or from about 0.001 mm to about 4 mm, or even from about 0.001 mm to about 0.9 mm.

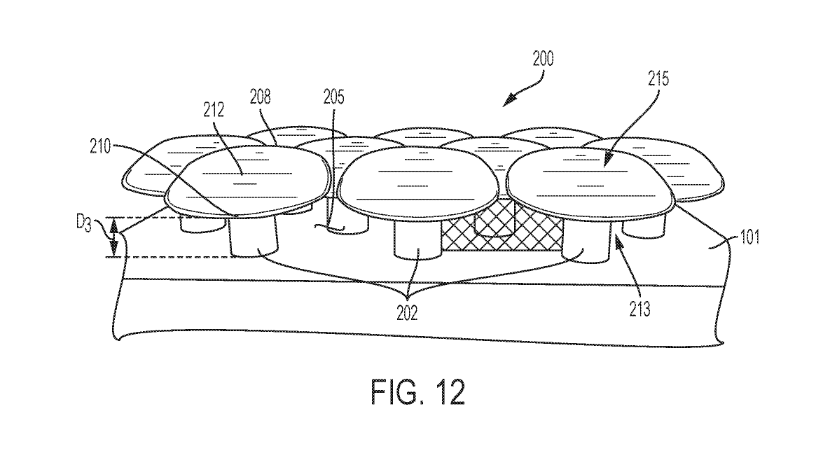

The connections between shield 206, support 202, and surface 101 are configured to resist the combustion temperatures and pressures within combustion chamber 102 during operation of engine 100. For example, support 202 may resist spalling from surface 101 for ≥100,000 miles inside operating engine 100. Support 202 may be applied to surface 101 using the various techniques disclosed herein. Thickness T2 of support 202 may be distinct from a thickness of material comprising surface 101 by the presence of a void volume 205. Surface 101 within combustion chamber 102 may be identified from support 202 by a lack of void volume 205. Alternatively or additionally, an interface at the joining of support 202 and surface 101 (caused by the bonding method) may help define thickness T2. FIGS. 12 & 14-16 provide an exemplary embodiment of thermal barrier 200 with shields 206 joined to surface 101 by supports 202.

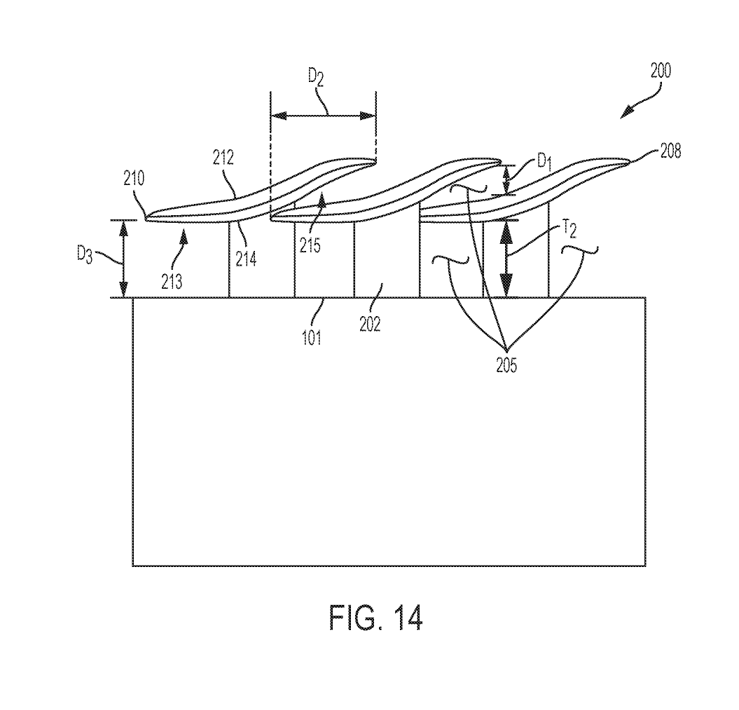

Support 202 may have any cross-sectional shape including rectangular, annular, hexagonal, and/or any other polygon shape. Each support 202 may have a circular cross-section as shown in FIG. 14. Thickness T2 of each support 202 may be from about 0.01 mm to about 10 mm, or from about 0.1 mm to about 2 mm, or from about 0.4 mm to about 2 mm, or even from about 0.5 mm to about 1 mm. In exemplary embodiments, thickness T2 of each support 202 is substantially uniform across the length and the width of thermal barrier 200 including the array of modules 201. Thickness T2 of support 202 may be measured from surface 101 to a termination point (or end) of support 202 away from surface 101 (e.g., where support 202 joins directly or indirectly with shield 206).

In embodiments, support 202 and shield 206 of module 201 may be a metal element or a metal alloy commonly used in combustion chamber 102 manufacturing. The metal or metal alloy may include carbon steel, stainless steel, aluminum alloy, aluminum, nickel plated aluminum, titanium alloy, hastelloy, nickel based super alloy, cobalt-based super alloy, and combinations thereof, for example. The metal or metal alloy encompassing support 202 and shield 206 may also be other super alloys including nickel, chromium, cobalt, and combinations thereof. The metal or metal alloy of support 202 and shield 206 may have the same (or different) coefficient of thermal expansion (CTE) as the material encompassing surface 101 (assuming similar operating temperature ranges) to minimize thermal expansion stresses and failures at their connection. In an exemplary embodiment, the CTE of the metal or metal alloy of support 202 and shield 206 may be within 150% of the CTE as the material encompassing surface 101 (assuming similar operating temperature ranges). In yet another embodiment, the CTE of the metal or metal alloy of support 202 may be within 150% of the CTE of the metal or metal alloy of shield 206.

In embodiments, a void volume 205 is defined between lower portion 214 of at least one shield 206 and upper portion 212 of an adjacent shield 206 in the module array. That is, void volume 205 may be defined between lower portion 214 and upper portion 212 of adjacent overlapping modules (i.e., between distance D1). In embodiments, void volume 205 is defined between overlapping portion 215 of at least one shield 206 and mounting portion 213 of at least one adjacent shield 206 in the module array. In embodiments, void volume 205 is further defined between lower portion 214 and surface 101 or overlapping portion 215 and surface 101. FIGS. 4-8, 10, 12, and 14 illustrate the location of void volume 205 below individual modules in the array.

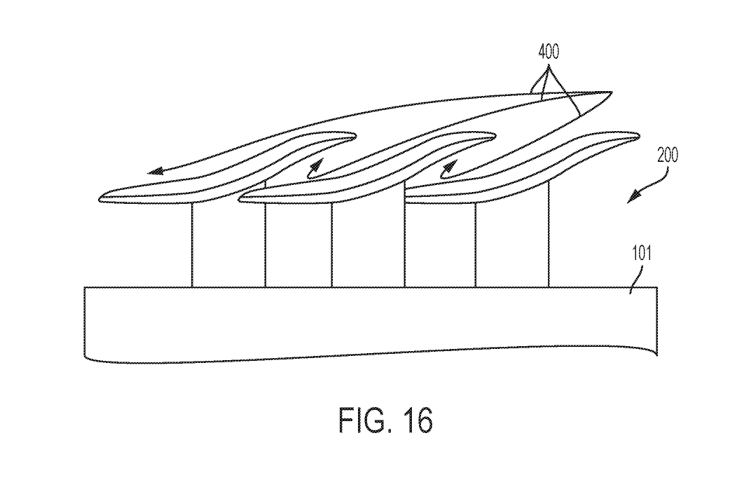

In embodiments, void volume 205 is configured to allow convective cooling of shields 205 in the module array after a combustion event. That is, combustion reaction products exiting the combustion chamber and combustion reactants (e.g., air, gasoline, diesel fuel, oil, etc.) entering the combustion chamber may flow into void volume 205 and absorb heat of combustion from shields 205 to cool thermal barrier 200. This may prevent a majority of the heat of combustion from reaching surface 101. Combustion reactants and products flowing from intake valve 106 to exhaust valve 114 may convectively cool thermal barrier 200 by exposure to upper portion 212 and a segment of lower portion 214 defining distance D1 and void volume 205. In embodiments, void volume 205 is configured to reduce fluid flow from exhaust valve 114 to intake valve 106 in combustion chamber 102. That is, as shown in FIG. 16, the flow of combustion reactants and/or products (shown by arrow 400) contiguous thermal barrier 200 may be reduced in one direction by interaction with void volume 205 between upper portion 212 of at least one module and lower portion 214 of an adjacent module in the array. In embodiments, void volume 205 is configured to improve convective cooling of the modules 201 in thermal barrier 200. In embodiments, void volume 205 is a tortuous volume around a plurality of supports 202 (defined by thickness T2) within the module array. In embodiments, void volume 205 may be a singular void space or a plurality of discrete and/or interconnected voids. In embodiments, void volume 205 extends across at least 50% of thickness T2, or substantially across thickness T2, or up to 100% of thickness T2. In embodiments, void volume 205 extends across distance D1. In embodiments, the volumetric ratio of support 202 to vacant volume 205 along a length, width, and thickness T2 of thermal barrier 200 may be from about 3:1 to about 1:20.

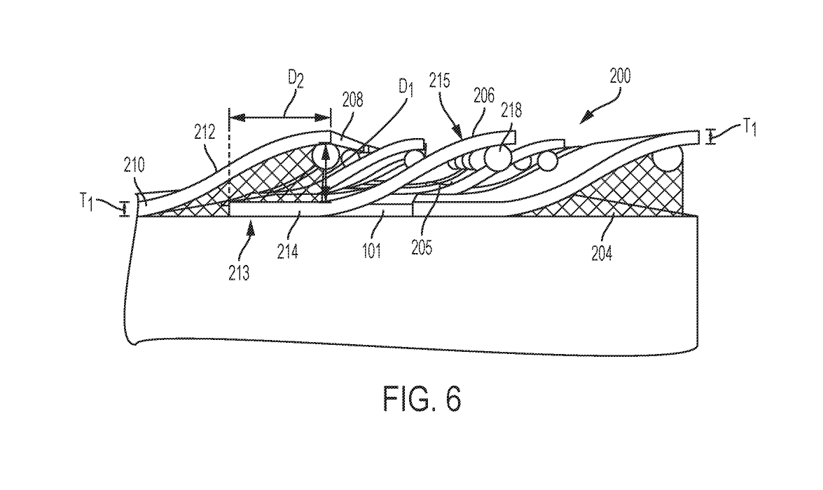

In embodiments where convective cooling of shields 206 is not desirable or possible (based on engine operation or performance), thermal barrier 200 may include an insulation material 204. In embodiments, insulation material 204 is contained with vacant volume 205 between shield 206 and surface 101. That is, vacant volume 205 is at least partially filled with insulation material 204. Thus, a portion of vacant volume 205 is occupied (or eliminated) by the presence of insulation material 204 therein. Insulation material 204 may fill from 5% to 99% of vacant volume 205. Referring to FIGS. 6, 10, and 12, insulation material 204 (shown as a cross-hatched area) is contained within vacant volume 205. In embodiments, the volumetric ratio of support 202 to insulation material 204 along a length, width, and thickness T1 in thermal barrier 200 may be from about 1:1 to about 1:5. In embodiments, insulation material 204 may fill the vacant volume defined along a length, width, and distance D1. In embodiments, insulation material 204 has a density gradient along distance D1. The volumetric ratio, density, and location of insulation material 204 may allow for “tuning” of thermal barrier 200 to achieve a desired thermal conductivity.

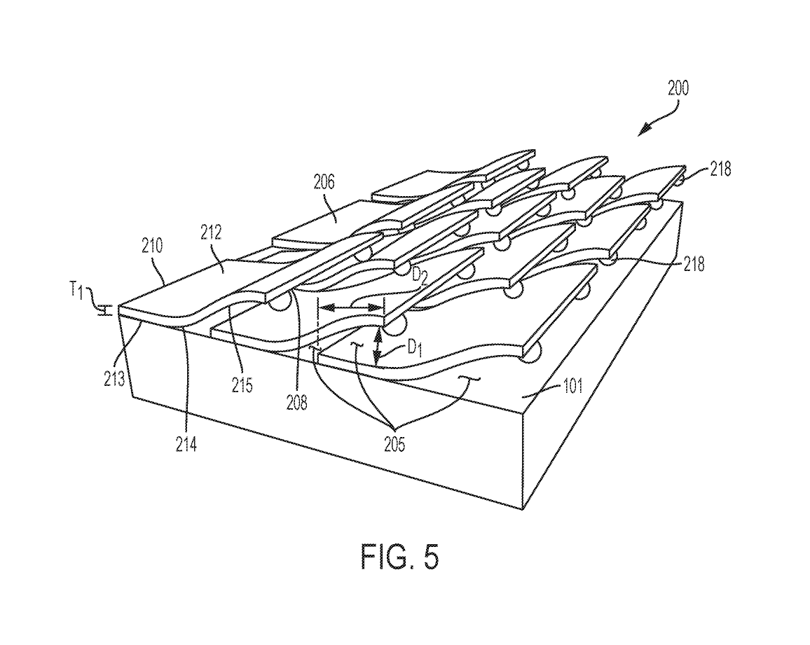

In an exemplary embodiment, insulation material 204 is interlocked within thickness T2 (between shields 206 and surface 101) and distance D2 (between upper portion 212 and lower portion 214 or between overlapping portion 215 and mounting portion 213) such that insulation material 204 does not escape, spall, or flake out from vacant volume 205 into combustion chamber 102 during operation of engine 100. In embodiments, surface 101, upper portion 212, and/or lower portion 214 of at least one shield 206 in the module array may be corrugated to prevent movement (via skin friction) or loss of insulation material 204 into combustion chamber 102 during operation of engine 100. In embodiments, lower portion 214 or overlapping portion 215 may include at least one member 218. Member 218 may be any shape, including spherical as depicted in FIGS. 5-7. Member 218 may be joined to lower portion 214 or overlapping portion 215 by metallic bonding, metal-to-metal bonding, or direct mechanical attachment methods described herein. Member 218 may be configured to partially enclose insulation material 204 within vacant volume 205. Member 218 may also prevent overlapping portion 215 from contacting mounting portion 312 during operation of the engine. Member 218 may also increase the volume and surface area of a shield and may assist with convective cooling of thermal barrier 200.

Insulation material 204 may be air, a ceramic material, and/or combinations thereof. In embodiments, insulation material 204 is any material that is capable of flowing or being contained within vacant volume 205 and with a thermal conductivity from about 0.01 W/m·K to about 12.0 W/m·K at 400° C., or from about 0.1 W/m·K to about 8.0 W/m·K at 400° C., or even from about 0.1 W/m·K to about 4.0 W/m·K at 400° C. Insulation material 204 is a composition having a low thermal conductivity to increase the thermal resistivity of thermal barrier 200 (when in vacant volume 205) such that more energy of combustion is available for performing work and powering engine 100.

In an embodiment where insulation material 204 includes ceramic material, the ceramic material may have a porosity from about 10% to about 90%, or from about 30% to about 70%. The pores of the ceramic material may include air. Example ceramic materials include, but are not limited to, yttria stabilized zirconia (YSZ), zirconium dioxide, lanthanum zirconate, gadolinium zirconate, lanthanum magnesium hexaaluminate, gadolinium magnesium hexaaluminate, lanthanum-lithium hexaaluminate, barium zirconate, strontium zirconate, calcium zirconate, sodium zirconium phosphate, mullite, aluminum oxide, cerium oxide, and combinations thereof. The ceramic material of exemplary embodiments may be ceramic foam. The ceramic material of exemplary embodiments may also be formed from aluminates, zirconates, silicates, titanates, and combinations thereof

In embodiments, the total thickness of thermal barrier 200 is from about 0.1 mm to about 10 mm, or from about 0.1 mm to about 5 mm. In an exemplary embodiment, thermal barrier 200 has a thermal conductivity of about 0.1 W/m·K to about 12 W/m·K at 400° C., or about 1 W/m·K to about 5 W/m·K at 400° C. Various embodiments of composite thermal barrier 200 on a surface within engine 100 are provided in FIGS. 4-14. Of course, combinations of these embodiments and other embodiments are in accordance with this disclosure.

Distance D1 may be from about 0.001 micron to about 10 mm, or from about 0.001 micron to about 5 mm, or from about 0.01 mm to about 5 mm, from about 1 mm to about 5 mm, or even from about 0.1 mm to about 3 mm. Distance D2 may be from about 0.001 micron to about 10 mm, or from about 0.1 mm to about 9 mm, or from about 1 mm to about 8 mm, or even from about 1 mm to about 5 mm. In embodiments, distance D1 and distance D2 are configured to allow penetration of combustion reactants and/or products into vacant volume 205 for convective cooling of shields 206. In embodiments, distance D1 and distance D2 are configured to limit or eliminate the spalling of insulation material 204 (if present in thermal barrier 200) out of vacant volume 205 into combustion chamber 102.

Thermal barrier 200 of the present disclosure improves conventional thermal barriers. Conventional thermal barriers may create a nonlinear temperature gradient between the combustion chamber surface on which the thermal barrier is attached and other adjacent surfaces which may be cooled by engine coolant. In one example, when a supported shield (or skin) is fixed to a surface of an internal combustion chamber, thermal expansion and contraction of the thermal barrier causes strain within the shield in areas between connection with the combustion chamber surface. That is, in conventional thermal barriers, discrete portions of the barrier are fixed to the combustion chamber surface and areas between the supports experience thermomechanical fatigue from expansion and contraction of the thermal barrier during temperature cycling in the combustion chamber. During heating, the continuous shield experiences compression in areas between the supports. During cooling, the continuous shield experiences tension in areas between the supports. This repeated process via temperature cycling in the combustion chamber can cause thermomechanical fatigue and failure.

Thermal barrier 200 of the present disclosure may reduce thermal strains and thermomechanical fatigue in areas between connection with the combustion chamber surface by providing breaks or segmentation in thermal barrier 200. That is, lower portion 214 and upper portion 212 of at least two shields 206 in the module array are spaced apart by a distance D1. In embodiments, overlapping portion 215 and mounting portion 213 of at least two shields 206 in the module array are spaced apart by a distance D1. Distance D1 is measured in the overlapping area (i.e., defined by distance D2) between adjacent shields 206 in the module array as shown in FIGS. 4-7. As shown in the FIGS. 4-7 embodiments, edge 208 of at least one shield in the module array overlaps with edge 210 of an adjacent shield 206 in the module array by distance D2. The shields 206 of the module array in the FIGS. 4-16 embodiments can be described as overlapping, segmented shields or scales. Of course, thermal barrier 200 may include a combination of non-overlapping and overlapping edges. In embodiments, the module array includes a repeating structural pattern. As shown in FIGS. 4-14, thermal barrier 200 includes a repeating pattern via the plurality of modules 201 organized in a specific configuration. Thermal barrier 200 may also include a non-repeating pattern or discontinuous pattern of modules on surface 101. Thermal barrier 200 may be located on “hot spots” within engine 100 to improve thermal resistance. Thus, by providing discrete overlapping shields or scales, thermal barrier 200 reduces thermal strains and thermomechanical fatigue in areas between connection with surface 101.

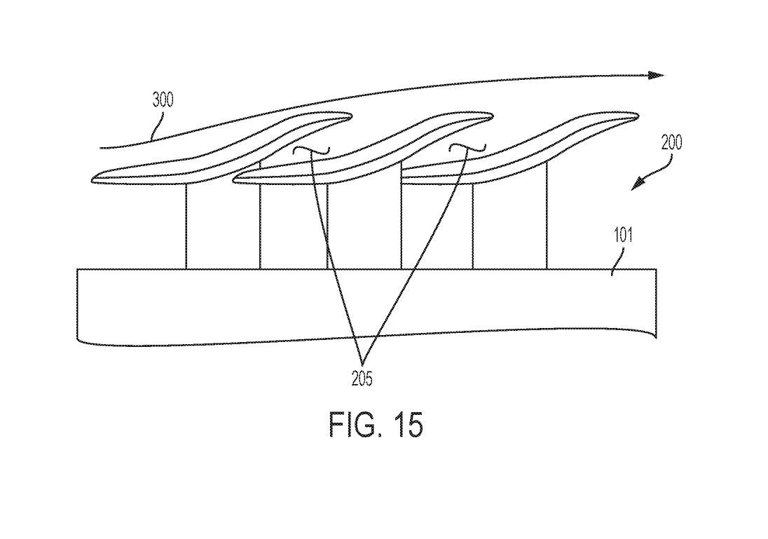

As shown in FIG. 15, thermal barrier 200 allows for limited obstruction of flow of combustion reactants and products (shown by arrow 300) in one direction. For examples, flow may be from intake valve 106 to exhaust valve 114 in accordance with normal operation of combustion chamber 102. As shown in FIG. 16, thermal barrier 200 may restrict flow (in the area defined by distance D1) of combustion reactants and products (shown by arrow 400) at least partially in the opposite direction in combustion chamber 102. For example, thermal barrier 200 may reduce flow from exhaust valve 114 to intake valve 106. In embodiments, thermal barrier 200 in FIGS. 15 and 16 are shown on surface 101 such that a combustion chamber intake valve would be arranged on the left side of the drawing, and an exhaust valve would be arranged on the right side of the drawing. In embodiments, first edges 208 of shields 206 in the module array are closer in proximity to exhaust valve 114 of combustion chamber 102 than opposite second edges 210. Accordingly, in embodiments, second edges 210 of shields 206 in the module array are closer in proximity to intake valve 106 of combustion chamber 102 than opposite first edges 210. That is, first edges 208 may act as a baffle and obstruct flow from exhaust valve 114 to intake valve 106. In embodiments, overlapping portion 215 of at least one shield 206 in the module array is closer in proximity to exhaust valve 114 of combustion chamber 102 than its mounting portion 213. In embodiments, mounting portion 213 of at least one shield 206 in the module array is closer to intake valve 106 than overlapping portion 215. In further embodiments, overlapping portion 215 of at least one shield 206 in the module array is closer to exhaust valve 114 that mounting portion 213.

The present disclosure also includes methods of applying thermal barrier 200 to metallic surface 101 within combustion chamber 102 of engine 100. The method includes preparing surface 101 for application of at least two modules 201. Preparing surface 101 may include roughening, chemical etching, drilling, cleaning, or other processes of readying surface 101 for application of the plurality of modules 201 thereon. It is envisioned that the method of preparation of surface 101 will likely depend on the method of applying the array of modules on surface 101.

Methods of making thermal barrier 200 may include forming an array of modules 201. Methods of making thermal barrier 200 may include forming or joining lower portion 214 of a plurality of shields 206 on surface 101. Methods of making thermal barrier 200 may also include forming or joining a plurality of supports 202 on shield 206. Joining the plurality of shields 206 on surface 101 or supports 202 on shield 206 includes 3-D printing, metallic plating, mechanical fastening or threading, fusion welding, brazing, resistance welding, diffusion bonding, sintering, or other conventional methods of metal-to-metal bonding. In embodiments, supports 202 may be joined directly or indirectly to surface 101 before supports 202 are joined directly or indirectly to at least one shield 206. Methods of making thermal barrier 200 may include deforming a portion of shield 206 to create distance D1 between edge 208 and another edge of an adjacent shield in the module array.

Methods of making thermal barrier 200 may include applying thermal barrier 200 to surface 101. Applying thermal barrier 200 to surface 101 includes joining directly or indirectly at least two shields 206 to surface 101. Applying thermal barrier 200 to surface 101 includes joining directly or indirectly at least two supports 202 to surface 101. Applying thermal barrier 200 to surface 101 includes joining directly or indirectly a plurality of modules to surface 101. A support 202 or shield 206 may be joined to surface 101 via 3-D printing, metallic plating, mechanical fastening or threading, fusion welding, brazing, resistance welding, diffusion bonding, sintering, or other conventional methods of metallically bonding support 202 to surface 101 via metal-to-metal bonds. Methods of applying thermal barrier 200 to surface 101 may include the formation of vacant volume 205. Vacant volume 205 may be formed by etching, drilling, or any other process of material or metal removal.

Methods of making thermal barrier 200 may also include deforming at least a segment of one shield 206 such that the outer edges of at least two module shields 206 are spaced apart by distance D1. Methods of making thermal barrier 200 may also include inserting insulation material 204 within vacant volume 205. Methods of inserting insulation material 204 within vacant volume 205 may include pressure application, injection, pressing, impregnating, and other conventional methods of inserting a solid or gas insulator in vacant volume 205. It is envisioned that inserting insulation material 204 within vacant volume 205 may be accomplished while applying shields 206 or supports 202 to surface 101.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

1. A thermal barrier comprising:
an array of modules each comprising a metallic shield,
each shield in the module array comprises a body with a first edge opposite a second edge and an upper portion opposite a lower portion,
the lower portion of each shield in the module array joins directly or
indirectly with a surface within a combustion chamber of an internal combustion engine,
the first edge of at least one shield in the module array overlaps the first or second edge of an adjacent shield in the module array, and
the first edge of the at least one shield is spaced apart from the upper portion of the adjacent shield in the module array by a first distance D1.

2. The thermal barrier of claim 1 wherein the first distance D1 is from about 0.01 mm to about 5 mm.

3. The thermal barrier of claim 1 wherein the first edge of at least one shield in the module array overlaps the first or second edge of an adjacent shield in the module array by a second distance D2.

4. The thermal barrier of claim 1 wherein the second edge of the at least one shield in the module array is spaced apart from the combustion chamber surface by a third distance D3.

5. The thermal barrier of claim 4, wherein the third distance D3 is from about 0.001 mm to about 0.9 mm.

6. The thermal barrier of claim 1 wherein the body of each module in the array comprises a substantially uniform thickness between the upper portion and lower portion.

7. The thermal barrier of claim 1 wherein at least one of the modules in the array further comprises a support, the support comprising a first end opposite a second end.

8. The thermal barrier of claim 7 wherein the first end of the at least one module support joins directly or indirectly with the combustion chamber surface, and wherein the second end of the at least one module support joins directly or indirectly with the lower portion of at least one shield in the module array.

9. The thermal barrier of claim 1 wherein the first edges of the shields in the module array are closer in proximity to an exhaust valve of the internal combustion chamber than the opposite second edges.

10. The thermal barrier of claim 1 wherein the second edges of the shields in the module array are closer in proximity to an intake valve of the internal combustion chamber than the opposite first edges.

11. The thermal barrier as in of claim 1 further comprising a void volume between the lower portion at least one shield in the module array and the combustion chamber surface, the void volume configured to reduce fluid flow from an exhaust valve of the internal combustion chamber to an intake valve of the internal combustion chamber.

12. The thermal barrier as in of claim 1 wherein the array of modules further comprises a repeating structural pattern.

13. The thermal barrier as in of claim 1 wherein the surface within the combustion chamber is at least one of: the top surface of a piston; a wall of a chamber compression volume; or a wall of a chamber exhaust volume.

14. A thermal barrier comprising:
an array of modules each comprising a metallic shield,
each shield in the module array comprising a body with a mounting portion and an overlapping portion,
the mounting portion of each shield in the module array joins directly or indirectly with a surface within a combustion chamber of an internal combustion engine,
the overlapping portion of at least one shield in the module array overlaps at least a segment of the mounting portion of at least one adjacent shield in the module array, and
the overlapping portion of the at least one shield in the module array is spaced apart by a first distance D1 from the mounting portion of the at least one adjacent shield in the module array.

15. The thermal barrier of claim 14 wherein at least one of the modules in the array further comprises a support, the support comprising a first end opposite a second end.

16. The thermal barrier of claim 15 wherein the first end of the at least one module support joins directly or indirectly with the combustion chamber surface, and wherein the second end of the at least one module support joins directly or indirectly with the mounting portion of at least one shield in the module array.

17. The thermal barrier of claim 14 wherein the first distance D1 is from about 1 mm to about 5 mm.

18. The thermal barrier of claim 14 wherein the overlapping portion of at least one shield in the module array overlaps at least a segment of the mounting portion of at least one adjacent shield in the module array by a second distance D2.

19. The thermal barrier of claim 14 wherein the mounting portion of at least one shield in the module array is spaced apart from the combustion chamber surface by a third distance D3.

20. The thermal barrier of claim 19 wherein the third distance D3 is from about 0.001 mm to about 4 mm.

21. The thermal barrier of claim 14 wherein the body of each module in the array comprises a substantially uniform thickness between an upper portion and a lower portion thereof

22. The thermal barrier of claim 14 wherein the overlapping portion of the at least one shields in the module array is closer in proximity to an exhaust valve of the internal combustion chamber than the mounting portion.

23. The thermal barrier of claim 14 further comprising a void volume between the overlapping portion of the at least one shield in the module array and the combustion chamber surface, the void volume configured to reduce fluid flow from an exhaust valve of the internal combustion chamber to an intake valve of the internal combustion chamber.

24. The thermal barrier of claim 14 wherein the array of modules further comprises a repeating structural pattern.

25. The thermal barrier of claim 14 wherein the surface within the combustion chamber is at least one of: the top surface of a piston; a wall of a chamber compression volume; or a wall of a chamber exhaust volume.

26-30. (canceled)
